(19) United States
(12) Patent Application Publication
(10) Pub. No.: US 2019/0058562 A1
(43) Pub. Date: Feb. 21, 2019

(54) METHOD FOR CONFIGURING SOUNDING REFERENCE SIGNAL IN WIRELESS COMMUNICATION SYSTEM

(71) Applicant: Samsung Electronics Co., Ltd., Suwon-si (KR)

(72) Inventors: Hyunil YOO, Suwon-si (KR); Chanhong KIM, Suwon-si (KR); Taeyoung KIM, Seoul (KR); Hyungju NAM, Gwangmyeong-si (KR); Jeehwan NOH, Suwon-si (KR)

(21) Appl. No.: 16/104,697

(22) Filed: Aug. 17, 2018

(30) Foreign Application Priority Data
Aug. 17, 2017 (KR) 10-2017-0104115

(51) Int. Cl. H04L 5/00; H04W 76/27

(52) U.S. Cl. CPC H04L 5/0051; H04L 5/0094; H04W 76/27

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. The present disclosure provides methods for allocating a Sounding Reference Signal (SRS) for CSI acquisition, UL beam management, or wideband transmission. A method includes receiving, from a base station, first sounding reference signal (SRS) configuration information including first SRS resource and a usage of the first SRS resource, receiving, from the base station, second SRS configuration information including second SRS resource and a usage of the second SRS resource, and transmitting, to the base station, first SRS based on the first SRS configuration information and a second SRS based on the second SRS configuration information.

### CROSS-REFERENCE TO RELATED APPLICATIONS AND CLAIM OF PRIORITY

The present application is related to and claims benefit under 35 U.S.C. § 119(a) based on a Korean patent application filed on Aug. 17, 2017 in the Korean Intellectual Property Office and assigned Serial number 10-2017-0104115, the entire disclosure of which is hereby incorporated by reference.

### BACKGROUND

### 1. Field

The disclosure relates to multi-antenna transmission. The present disclosure provides methods for allocating a Sounding Reference Signal (SRS) for CSI acquisition, UL beam management, or wideband transmission.

### 2. Description of Related Art

The above information is presented as background information only to assist with an understanding of the present disclosure. No determination has been made, and no assertion is made, as to whether any of the above might be applicable as prior art with regard to the present disclosure.

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

Beamforming is a technique by which radio waves are concentrated to arrive on an area in a particular direction using two or more array antennas to thereby increase the transmission distance, while the strength of signals received in directions other than the particular direction is decreased to reduce unnecessary signal interference. When beamforming is applied, an increase in a service area and a reduction in interfering signals may be expected.

To support communication for beamforming, beamforming for an uplink and a downlink is necessary, in which it is very efficient to use a Sounding Reference Signal (SRS) as a training signal for uplink beamforming. However, UE-specific SRS transmission is performed in a subframe allocated through a cell-specific SRS configuration. Therefore, it is necessary to consider employing an SRS for Channel State Information (CSI) acquisition and an SRS for beam management.

5G communication employs not only beamforming but also the concept of a bandwidth part (BWP). A bandwidth part is a concept whereby the bandwidth that is supportable by a User Equipment (UE) is set within a system bandwidth and is employed as a bandwidth part when the UE does not have the capability to support the entire system bandwidth.

However, when the UE is not capable of supporting the entire bandwidth, the UE cannot transmit an SRS by performing frequency hopping in the entire bandwidth. Therefore, a new signal is needed for frequency hopping between bandwidth parts considering the bandwidth of a bandwidth part or the entire bandwidth.

### SUMMARY

In accordance with an aspect of the disclosure, there is provided a method for allocating a Sounding Reference Signal (SRS) for CSI acquisition, uplink beam measurement, or wideband transmission.

Embodiments of the disclosure may provide a method for operating a terminal, the method including: receiving, from a base station, first sounding reference signal (SRS) configuration information including first SRS resource and a usage of the first SRS resource; receiving, from the base station, second SRS configuration information including second SRS resource and a usage of the second SRS resource; and transmitting, to the base station, first SRS based on the first SRS configuration information and a second SRS based on the second SRS configuration information.

Embodiments of the disclosure may provide a terminal including: a transceiver configured to transmit and receive a signal; and a controller configured to: receive, from a base station, first sounding reference signal (SRS) configuration information including first SRS resource and a usage of the first SRS resource, receive, from the base station, second SRS configuration information including second SRS resource and a usage of the second SRS resource, and transmit, to the base station, first SRS based on the first SRS configuration information and a second SRS based on the second SRS configuration information.

Embodiments of the disclosure may provide a method for operating a base station, the method including: transmitting, to a terminal, first sounding reference signal (SRS) configuration information including first SRS resource and a usage of the first SRS resource; Transmitting, to the terminal, second SRS configuration information including second SRS resource and a usage of the second SRS resource; and receiving, from the terminal, first SRS based on the first SRS configuration information and a second SRS based on the second SRS configuration information.

Embodiments of the disclosure may provide a base station including: a transceiver configured to transmit and receive a signal; and a controller configured to: transmitting, to a terminal, first sounding reference signal (SRS) configuration information including first SRS resource and a usage of the first SRS resource, transmitting, to the terminal, second SRS configuration information including second SRS resource and a usage of the second SRS resource, and receive, from the terminal, first SRS based on the first SRS configuration information and a second SRS based on the second SRS configuration information.

According to an embodiment of the disclosure, an SRS may be allocated to enable uplink channel information acquisition and uplink beam measurement. Further, it is possible to transmit an SRS using frequency hopping in consideration of a wideband.

### BRIEF DESCRIPTION OF THE DRAWINGS

For a more complete understanding of the present disclosure and its advantages, reference is now made to the following description taken in conjunction with the accompanying drawings, in which like reference numerals represent like parts, and wherein:

FIG. 1 illustrates an example of a method for operating a common SRS for CSI acquisition and UL beam management according to an embodiment of the disclosure;

FIG. 2 illustrates an example of a method for independently operating SRSs for CSI acquisition and UL beam management according to an embodiment of the disclosure;

FIG. 3 illustrates UE-specific SRS transmission according to a cell-specific SRS configuration according to an embodiment of the disclosure;

FIG. 4 illustrates frequency-hopping transmission according to a system bandwidth and a UE bandwidth according to an embodiment of the disclosure;

FIG. 5 illustrates an example of SRS frequency-hopping transmission according to a bandwidth part according to an embodiment of the disclosure;

FIG. 6 illustrates the operation of a base station for setting a bandwidth part with a common bandwidth size and for supporting a frequency-hopping SRS according to an embodiment of the disclosure;

FIG. 7 illustrates the operation of a UE for setting a bandwidth part with a common bandwidth size and for supporting a frequency-hopping SRS according to an embodiment of the disclosure;

FIG. 8 illustrates the SRS reception operation of a base station according to a UE-specific SRS BW and a UE BW according to an embodiment of the disclosure;

FIG. 9 illustrates the SRS transmission operation of a UE according to a UE-specific SRS BW and a UE BW according to an embodiment of the disclosure;

FIG. 10 illustrates a signaling example for a base station to support frequency hopping within a bandwidth part and a system bandwidth according to an embodiment of the disclosure;

FIG. 11 illustrates a signaling example for a UE to support frequency hopping within a bandwidth part and a system bandwidth according to an embodiment of the disclosure;

FIG. 12 illustrates SRS frequency-hopping transmission between bandwidth parts in a system bandwidth according to an embodiment of the disclosure;

FIG. 13 illustrates the structure of a UE according to an embodiment of the disclosure; and

FIG. 14 illustrates the structure of a base station according to an embodiment of the disclosure.

### DETAILED DESCRIPTION

Hereinafter, embodiments of the present disclosure will be described in detail in conjunction with the accompanying drawings. In the following description of the present disclosure, a detailed description of known functions or configurations incorporated herein will be omitted when it may make the subject matter of the present disclosure rather unclear. The terms which will be described below are terms defined in consideration of the functions in the present disclosure, and may be different according to users, intentions of the users, or customs. Therefore, the definitions of the terms should be made based on the contents throughout the specification.

The advantages and features of the present disclosure and ways to achieve them will be apparent by making reference to embodiments as described below in detail in conjunction with the accompanying drawings. However, the present disclosure is not limited to the embodiments set forth below, but may be implemented in various different forms. The following embodiments are provided only to completely disclose the present disclosure and inform those skilled in the art of the scope of the present disclosure, and the present disclosure is defined only by the scope of the appended claims. Throughout the specification, the same or like reference numerals designate the same or like elements.

In order to meet the demand for wireless data traffic, which has been increasing since the commercialization of a fourth-generation (4G) communication system, efforts are being made to develop an improved fifth-generation (5G) communication system or pre-5G communication system. For this reason, a 5G communication system or pre-5G communication system is referred to as a beyond-4G-network communication system or a post-LTE system.

To achieve a high data transmission rate, implementing a 5G communication system in an extremely high frequency (mmWave) band (for example, a 60 GHz band) is being considered. To relieve the path loss of radio signals and to increase the transmission distance of radio signals in an extremely high frequency band, beamforming, massive Multiple-Input and Multiple-Output (massive MIMO), Full Dimensional MIMO (FD-MIMO), array antenna, analog beamforming, and large-scale antenna techniques are under discussion for a 5G communication system.

Beamforming is a technique by which radio waves are concentrated to arrive on an area in a particular direction using two or more array antennas to thereby increase the transmission distance, while the strength of signals received in directions other than the particular direction is decreased to thus reduce unnecessary signal interference. When beamforming is applied, it may be expected to increase a service area and to reduce interfering signals. To this end, however, it is necessary to match the directions of beams from a base station and a User Equipment (UE) to form an optimal beam. That is, it is necessary to find the beam direction having the optimal beam intensity. In this specification, a UE may be referred to as a terminal and a base station may be referred to as a gNB.

For a downlink (DL), a periodic synchronization signal or a UE-specific Channel State Information-Reference Signal (CSI-RS) may be used as a training signal for beamforming. A CSI-RS is used as a DL beam training signal in FD-MIMO.

For an uplink (UL), however, a training signal for beamforming is not defined. A Random Access Channel (RACH), a Sounding Reference Signal (SRS), or a UL DeModulation Reference Signal (UL DMRS) may be considered as a UL beam training signal. However, among these signals, a RACH and a UL DMRS do not have periodicity.

For an SRS, in LTE, an SRS subframe that a UE actually transmits is specified and transmitted through a cell-specific SRS configuration and a UE-specific SRS configuration. The method for transmitting an SRS in LTE is described in detail below.

TABLE 1
<SRS subframe configuration for frame structure 2>

| | | | Transmission |
|---|---|---|---|
| | | Configuration Period | offset |
| srs-SubframeConfig | Binary | T_{SFC} (subframes) | Δ_{SFC} (subframes) |
| 0 | 0000 | 5 | {1} |
| 1 | 0001 | 5 | {1, 2} |
| 2 | 0010 | 5 | {1, 3} |
| 3 | 0011 | 5 | {1, 4} |
| 4 | 0100 | 5 | {1, 2, 3} |
| 5 | 0101 | 5 | {1, 2, 4} |
| 6 | 0110 | 5 | {1, 3, 4} |
| 7 | 0111 | 5 | {1, 2, 3, 4} |
| 8 | 1000 | 10 | {1, 2, 6} |
| 9 | 1001 | 10 | {1, 3, 6} |
| 10 | 1010 | 10 | {1, 6, 7} |
| 11 | 1011 | 10 | {1, 2, 6, 8} |
| 12 | 1100 | 10 | {1, 3, 6, 9} |
| 13 | 1101 | 10 | {1, 4, 6, 7} |
| 14 | 1110 | reserved | reserved |
| 15 | 1111 | reserved | reserved |

Table 1 shows an SRS period and offset according to srs-SubframeConfig transmitted as a cell-specific parameter. In LTE, different SRS subframes may be determined according to Frequency-Division Duplexing (FDD) and Time-Division Duplexing (TDD). An embodiment of the present disclosure, however, illustrates a method in TDD as a method for determining a subframe transmitting an SRS. srs-SubframeConfig is transmitted to a UE through a System Information Block (SIB), and the UE estimates a subframe index satisfying └nₛ/2┘ mod T_{SFC}∈Δ_{SFC} using the SRS period and offset values illustrated in Table 1.

TABLE 2
Subframe index (kₛᵣₛ) within frame for TDD

| subframe index n | | | | | | | | | | | |
|---|---|---|---|---|---|---|---|---|---|---|---|
| | 1 | | | | | | 6 | | | | |
| | 1st symbol | 2nd symbol | | | | | 1st symbol | 2nd symbol | | | |
| 0 | of UpPTS | of UpPTS | 2 | 3 | 4 | 5 | of UpPTS | of UpPTS | 7 | 8 | 9 |

| | | | | | | | | | | |
|---|---|---|---|---|---|---|---|---|---|---|
| k_{SRS} in case | 0 | 1 | 2 | 3 | 4 | 5 | 6 | 7 | 8 | 9 |
| UpPTS length of 2 | | | | | | | | | | |
| symbols | | | | | | | | | | |
| k_{SRS} in case | 1 | | 2 | 3 | 4 | 6 | | 7 | 8 | 9 |
| UpPTS length of 1 | | | | | | | | | | |
| symbol | | | | | | | | | | |

Table 2 shows a UE-specific subframe index for transmitting an SRS where the length of UpPTS is 1 or 2 in LTE. Since the length of one frame is 10 ms, a subframe index value is defined to support a period of 2, 5, or 10 ms.

<Table 3: UE-Specific SRS Periodicity T_{SRS} and Subframe Offset Configuration T_{offset} for Trigger Type 0, TDD>

TABLE 3

| SRS Configuration Index | SRS Periodicity | SRS Subframe Offset |
|---|---|---|
| I_{SRS} | T_{SRS} (ms) | T_{offset} |
| 0 | 2 | 0, 1 |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS}-10 |
| 15-24 | 10 | I_{SRS}-15 |
| 25-44 | 20 | I_{SRS}-25 |
| 45-84 | 40 | I_{SRS}-45 |
| 85-164 | 80 | I_{SRS}-85 |
| 165-324 | 160 | I_{SRS}-165 |
| 325-644 | 320 | I_{SRS}-325 |
| 645-1023 | reserved | reserved |

Table 3 shows a table for determining a UE-specific SRS subframe. In LTE, a UE-specific SRS transmission subframe index may be finally determined using the values illustrated in Tables 2 and 3. The SRS configuration index illustrated in Table 3 is transmitted to a UE through a UE-specific RRC configuration. Trigger type 0 illustrated in Table 3 refers to periodic SRS transmission.

For a subframe transmitting an SRS, a cell-specific SRS subframe illustrated in Table 1 is estimated, and an SRS is transmitted in the same subframe as that transmitting a UE-specific SRS within the estimated cell-specific SRS subframe.

As described above, beamforming for a UL and a DL is required to support communication for beamforming, in which case it is very efficient to use an SRS as a training signal for UL beamforming. However, as described above, UE-specific SRS transmission is performed in a cell-specific SRS subframe. An SRS for CSI acquisition and an SRS for beam management may be used according to the following two methods.

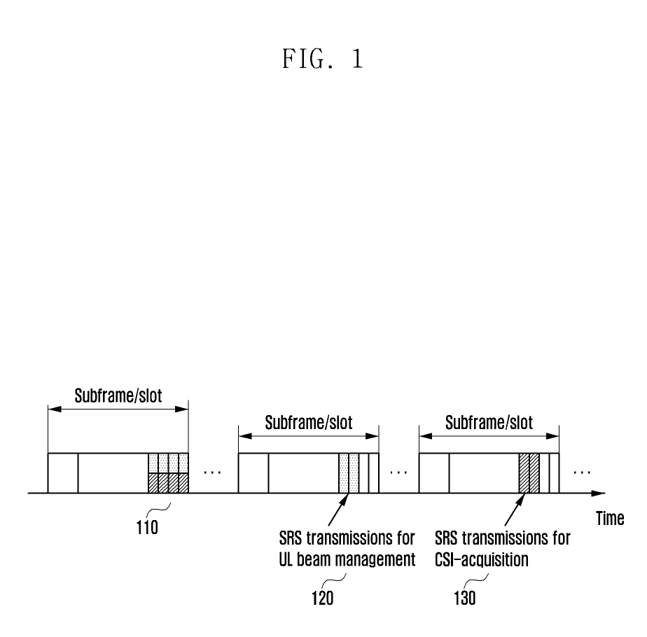

In a first method, as illustrated in FIG. 1, a cell-specific SRS configuration is shared, and an SRS for beam management and an SRS for CSI acquisition are used separately according to a UE-specific SRS configuration.

In FIG. 1, 110 indicates that the same subframe transmits an SRS for CSI acquisition and an SRS for beam management. 120 and 130 illustrate an embodiment in which only an SRS having one purpose is transmitted, unlike 110 in which SRSs for two different purposes are simultaneously transmitted. For resource management, it is obvious that it is very efficient to transmit SRSs having different purposes in cell-specific reserved resources, as in 110. However, SRS transmission for UL beam management is for beam training, and thus a base station or a UE needs to be able to change a beam while receiving or transmitting an SRS over a plurality of symbols. That is, since two symbols are set as SRS symbols for UL beam management in a resource illustrated in 120, the base station or the UE can receive or transmit a signal while changing a receiving or transmitting beam up to two times. In 110, four symbols are allocated for an SRS, in which case when the base station receives an SRS while changing a base station beam for four symbols, an SRS transmitted by the UE for CSI acquisition may not arrive at the base station because it is not guaranteed that the receiving beam of the base station and a transmitting beam of the UE are oriented in the optimal direction. Therefore, an SRS for CSI acquisition and an SRS for UL beam management are very difficult to multiplex with each other, and need to use independent resources, as in 120 and 130. Although independent resource management as in 120 and 130 is possible due to operation of the base station, a subframe index determined on Tables 2 and 3 is not a physical index but a logical index, and thus independent resource management for SRS transmission is actually very difficult. Therefore, a method of separating different resources for the SRSs through a cell-specific SRS configuration is more efficient in terms of operation.

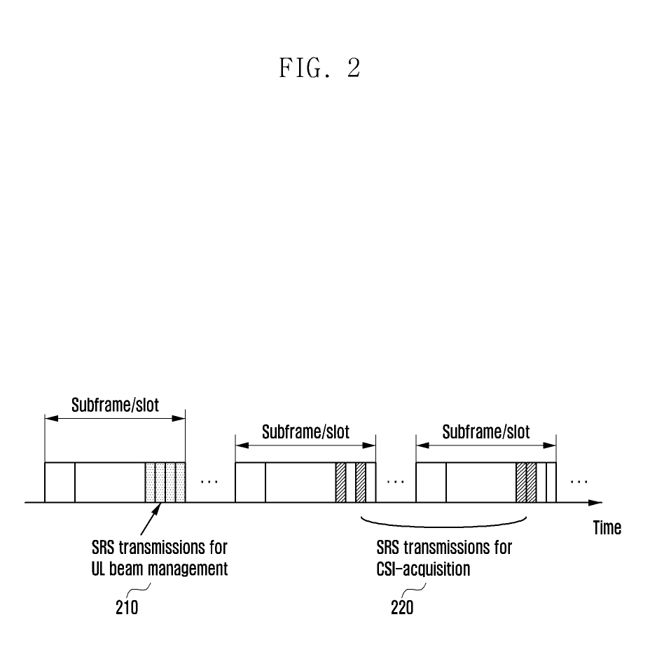

In a second method, cell-specific SRS configurations for UL beam management and for CSI acquisition are independently defined, and beam management and CSI acquisition are performed in corresponding SRS resources. That is, as illustrated in FIG. 2, different SRS transmission resources 210 and 220 may be allocated through the different cell-specific SRS configurations. FIG. 2 illustrates an example of a method for independently operating SRSs for CSI acquisition and UL beam management.

Since up to four symbols in a subframe/slot may be considered for SRS transmission for UL beam management and for CSI-RS acquisition, corresponding symbols may be logically extended as an SRS subframe, thereby extending the UE-specific SRS subframe illustrated in Table 2 to the one illustrated in Table 4.

<Table 4: Embodiment of SRS Subframe Extended to Up to Four Symbols in Slot>

TABLE 4

| | Slot index n | | | | | | | | |
|---|---|---|---|---|---|---|---|---|---|
| | 0 | | | | | 9 | | | |
| | 1^{st} | 2^{nd} | 3^{rd} | 4^{th} | | 1^{st} | 2^{nd} | 3^{rd} | 4^{th} |
| | sym- | sym- | sym- | sym- | | sym- | sym- | sym- | sym- |
| | bol | bol | bol | bol | . . . | bol | bol | bol | bol |
| K_SRS | 3 | X | X | X | | 39 | X | X | X |
| when | | | | | | | | | |
| N = 1 | | | | | | | | | |
| K_SRS | 2 | 3 | X | X | | 38 | 39 | X | X |
| when | | | | | | | | | |
| N = 2 | | | | | | | | | |
| xK_SRS | 1 | 2 | 3 | X | | 37 | 38 | 39 | X |
| when | | | | | | | | | |
| N = 3 | | | | | | | | | |
| K_SRS | 0 | 1 | 2 | 3 | | 36 | 37 | 38 | 39 |
| when | | | | | | | | | |
| N = 4 | | | | | | | | | |

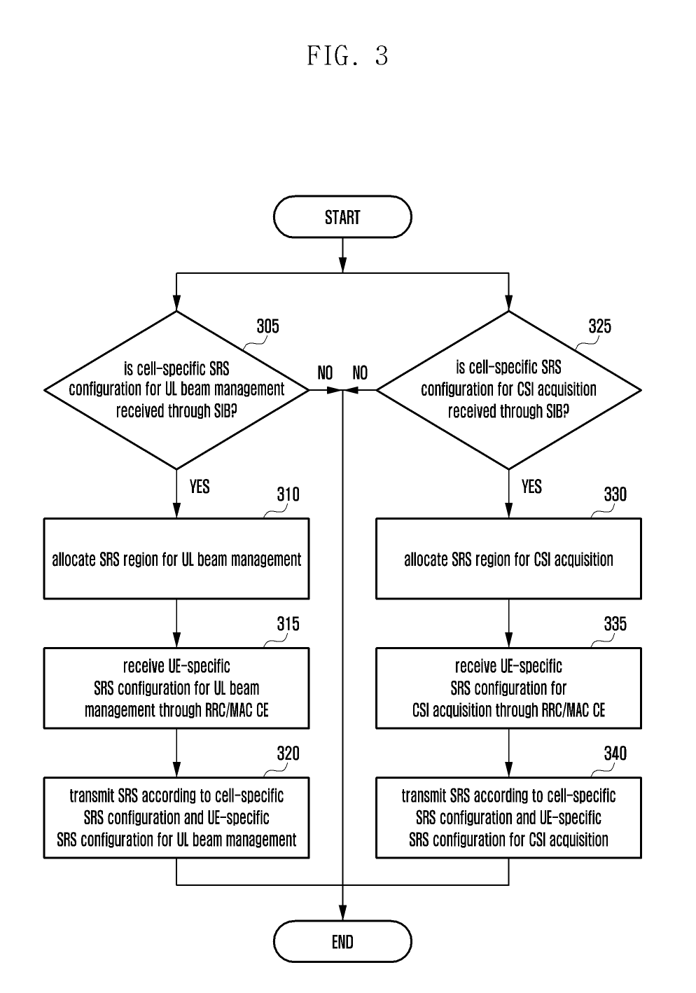

FIG. 3 illustrates UE-specific SRS transmission according to a cell-specific SRS configuration.

As in the second method described above, cell-specific SRS configurations for UL beam management and for CSI acquisition may be independently defined and transmitted to a UE. A system that does not consider beamforming does not need UL beam management and thus may consider a UL beam management SRS as a subsidiary configuration except for the purpose of allocating different resources for SRSs for different purposes.

In operation 305, the UE determines whether a cell-specific SRS configuration for UL beam management is received through an SIB. When the cell-specific SRS configuration is received, the UE performs operation 310; otherwise, the UE terminates the procedure of FIG. 3. The UE determines whether a cell-specific SRS configuration for CSI acquisition is received through an SIB in operation 325. When the cell-specific SRS configuration is received, the UE performs operation 330; otherwise, the UE terminates the procedure of FIG. 3. When the UE obtains the cell-specific SRS configuration for CSI acquisition or UL beam management, the UE may, with reference to Table 4 (310 or 330), be allocated a UE-specific resource within each resource allocated to a specific cell.

An SRS may be used for UL beam measurement and thus needs a configuration considering a process for training both transmitting and receiving beams of a base station and a UE, a process for training the receiving beam of the base station, and a process for training the transmitting beam of the UE. Therefore, a configuration set for the UL beam training process is defined, and information (e.g., two bits) indicating which process is to be performed through a DCI, MAC CE, or RRC message is required (315). That is, the UE may receive a UE-specific SRS configuration for UL beam management through RRC, MAC CE, or DCI. The UE may transmit an SRS on the basis of the cell-specific SRS configuration and the UE-specific SRS configuration for UL beam management (320).

Further, the UE may receive a UE-specific SRS configuration for CSI acquisition through RRC, MAC CE, or DCI (335). Then, the UE may transmit an SRS on the basis of the cell-specific SRS configuration and the UE-specific SRS configuration for CSI acquisition.

5G communication employs not only beamforming but also the concept of a bandwidth part. A bandwidth part is a concept whereby the bandwidth supportable by a User Equipment (UE) is set within a system bandwidth and is employed as a bandwidth part when the UE does not have the capability to support the system bandwidth. For example, when a bandwidth supportable by a UE is 10 MHz and a system bandwidth is 100 MHz, a bandwidth part is set to a value smaller than 10 MHz, which is the bandwidth supportable by the UE, and an operation is performed within the bandwidth part.

In LTE, an SRS operates as follows. A base station transmits a cell-specific SRS configuration to a UE through an SIB. The cell-specific SRS configuration includes time/frequency information for SRS transmission. Table 5 shows a cell-specific SRS configuration in LTE.

TABLE 5
Cell-specific SRS configuration

| | |
|---|---|
| SoundingRS-UL-ConfigCommon ::= | CHOICE { |

| | |
|---|---|
| release | NULL, |
| setup | SEQUENCE { |

| | |
|---|---|
| srs-BandwidthConfig | ENUMERATED {bw0, bw1, bw2, bw3, bw4, bw5, bw6, bw7}, |
| srs-SubframeConfig | ENUMERATED { |

sc0, sc1, sc2, sc3, sc4, sc5, sc6, sc7,
sc8, sc9, sc10, sc11, sc12, sc13, sc14, sc15},

| ackNackSRS-SimultaneousTransmission | BOOLEAN, | | |
|---|---|---|---|
| srs-MaxUpPts | ENUMERATED {true} | OPTIONAL | -- Cond TDD |

}

}

Here, srs-BandwidthConfig indicates a frequency resource for SRS transmission, and srs-SubframeConfig indicates a time resource for SRS transmission. When a frequency resource (entire bandwidth) is determined through a cell-specific SRS parameter, the UE transmits an SRS over wideband one-shot transmission or narrowband frequency hopping in the entire bandwidth. Therefore, a power-limited UE at a cell edge may be allocated a sub-band SRS and may transmit an SRS while performing frequency hopping in the entire system bandwidth. That is, as in

$$( \begin{matrix}frequency hoppind enabled & if {b}_{SYS} < {B}_{STS} \\ not enabled & otherwise\end{matrix} ,$$

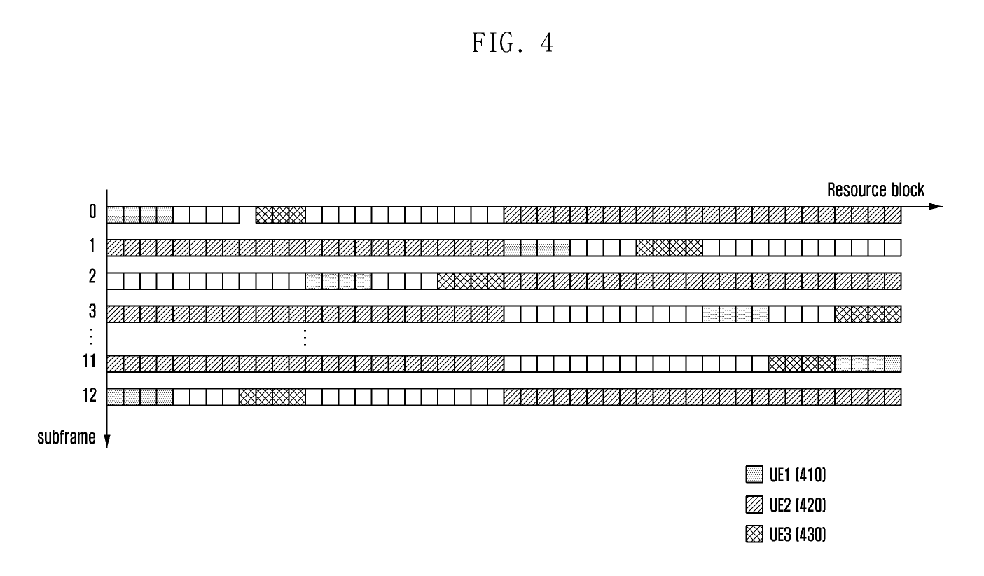

when a UE-specifically allocated UE SRS bandwidth (b_srs) is smaller than the entire SRS bandwidth, the UE transmits a periodic SRS by frequency hopping, as illustrated in FIG. 4. FIG. 4 illustrates frequency-hopping transmission according to a system bandwidth and a UE bandwidth.

As illustrated in FIG. 4, UEs 410, 420, and 430 may be allocated different UE bandwidths and accordingly perform transmission while performing frequency hopping to cover the entire bandwidth.

However, as described above, a UE may not be capable of supporting the entire bandwidth and thus cannot transmit an SRS by performing frequency hopping in the entire bandwidth. That is, as illustrated in FIG. 4, frequency hopping cannot be supported, and thus a new signal for frequency hopping is required.

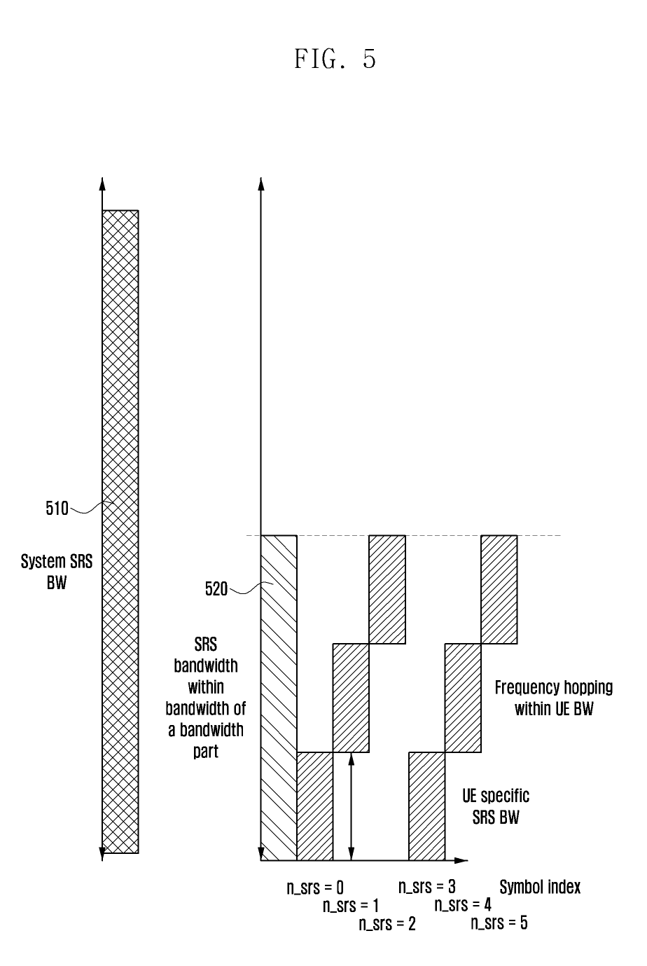

FIG. 5 illustrates an example of SRS frequency-hopping transmission according to a bandwidth part.

As illustrated in FIG. 5, when a UE bandwidth corresponding to the entire SRS bandwidth 520 is defined in a bandwidth part other than a system bandwidth 510, information indicating the entire bandwidth transmitted in a cell-specific SRS configuration may be UE-specifically allocated.

There are two methods for determining the UE bandwidth corresponding to the entire SRS bandwidth 520 within a bandwidth of the bandwidth part.

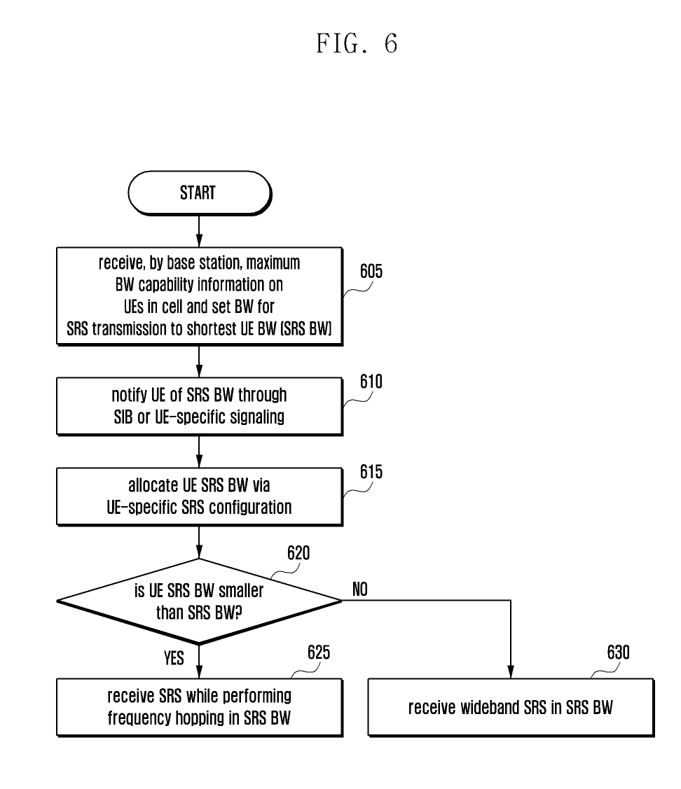

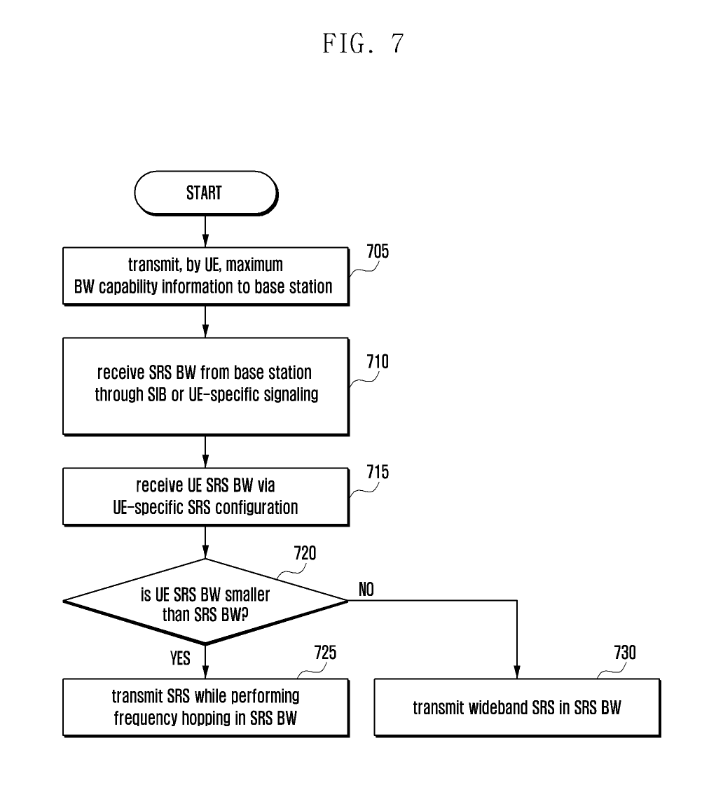

A first method is sharing the UE bandwidth so that all UEs have the same hopping pattern. The bandwidth part is allocated to be smaller than the maximum bandwidth capability of the UE reported by the UE to a base station. The base station allocates the UE bandwidth to be supported by all UEs' bandwidth parts so that all UEs have the same hopping pattern. That is, the base station allocates UE bandwidth=min (bandwidth parts of UEs in a cell) and reports this information to the UE through a cell-specific SRS/UE-specific SRS configuration. FIG. 6 illustrates the operation of a base station for setting a bandwidth in a bandwidth part with a common bandwidth size so that all UEs have the same hopping pattern and for supporting a frequency-hopping SRS, and FIG. 7 illustrates the operation of a UE therefor.

Referring to FIG. 6, in operation 605, the base station receives maximum bandwidth capability information from at least one UE in a cell. The base station sets a bandwidth for the UE to transmit an SRS to the UE bandwidth of the UE having the smallest maximum bandwidth capability value among the at least one UE on the basis of the information received from the UE. The bandwidth for the UE to transmit the SRS may be defined as an SRS BW, which is an SRS BW that is common to a plurality of UEs in the cell.

In operation 610, the base station may transmit information indicating the SRS BW to the UE. For example, the base station may transmit the SRS BW to the at least one UE via an SIB or UE-specific signaling.

In operation 615, the base station may allocate a UE SRS BW via a UE-specific SRS configuration.

In operation 620, the base station compares the width of the SRS BW, which is information common to the UEs in the cell, and the width of the UE SRS BW. When the UE SRS BW is smaller than the SRS BW, the base station performs operation 625; when the UE SRS BW is larger (or wider) than the SRS BW, the base station performs operation 630.

In operation 625, the base station receives an SRS from the UE while performing frequency hopping in the SRS BW. In operation 630, the base station receives a wideband SRS from the UE in the SRS BW.

Referring to FIG. 7, in operation 705, the UE transmits maximum bandwidth capability information to the base station.

In operation 710, the UE receives an SRS BW from the base station. The UE may receive the SRS BW from the base station via an SIB or UE-specific signaling. The SRS BW may be set to the UE bandwidth of the UE having the smallest maximum bandwidth capability value among maximum bandwidths received from UEs.

In operation 715, the UE may receive a UE SRS BW from the base station via a UE-specific SRS configuration.

In operation 720, the UE compares the width of the SRS BW, which is common information to the UEs in the cell, and the width of the UE SRS BW. When the UE SRS BW is smaller than the SRS BW, the UE performs operation 725; when the UE SRS BW is greater (or wider) than the SRS BW, the UE performs operation 730.

In operation 725, the UE transmits an SRS to the base station while performing frequency hopping in the SRS BW. In operation 730, the UE transmits a wideband SRS to the base station in the SRS BW.

A second method for determining the UE bandwidth corresponding to the entire SRS bandwidth 520 within the bandwidth of the bandwidth part is allocating a BW that each UE actually needs to cover, that is, a UE BW having a different width, to each UE. That is, a parameter indicating the entire bandwidth, srs-BandwidthConfig, may be provided to the UE through a UE-specific SRS configuration. Further, the UE BW may be forwarded to the UE via MAC CE or DCI. In addition, the UE BW may be allocated not only via a (cell-specific or UE-specific) SRS configuration but also via a data channel before or after the SRS configuration is allocated. Therefore, before transmitting an SRS, the UE needs to transmit, in advance, UE BW information corresponding to the bandwidth in the bandwidth part of the UE to the base station.

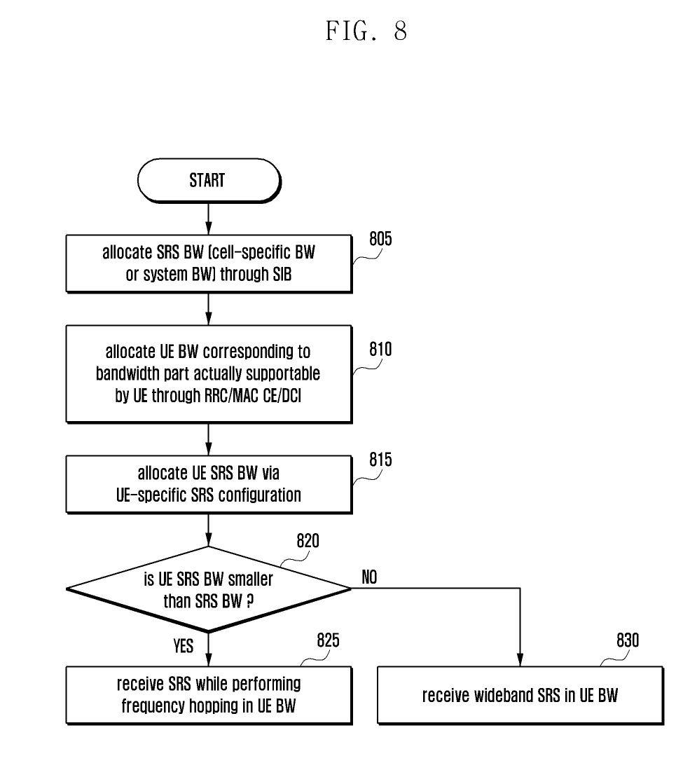

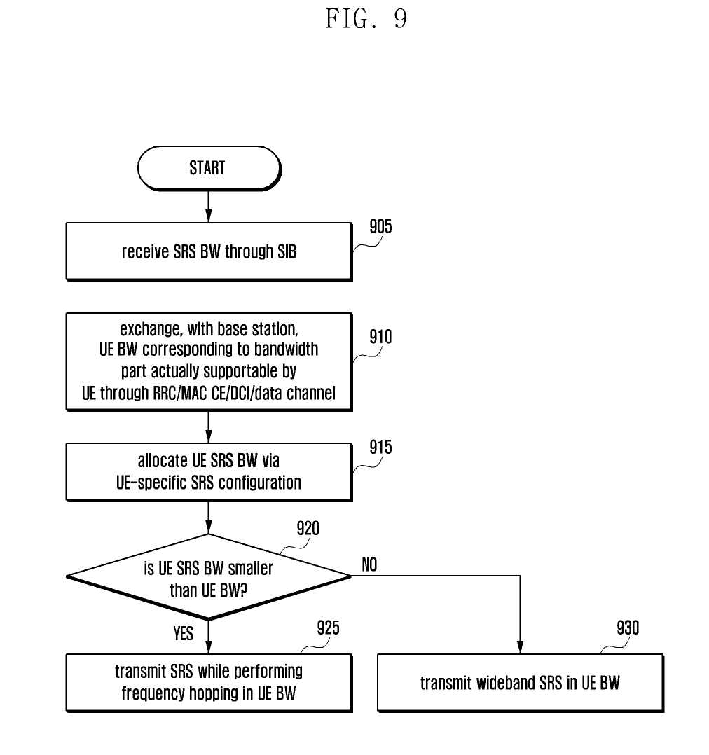

FIG. 8 illustrates the operation of a base station for setting a bandwidth for each UE in a bandwidth part and for supporting a frequency-hopping SRS, and FIG. 9 illustrates the operation of a UE therefor.

Referring to FIG. 8, in operation 805, the base station may allocate an SRS BW (cell-specific BW or system BW) through an SIB. In operation 810, the base station allocates a UE BW corresponding to a bandwidth part that the UE can actually support through RRC, MAC CE, or DCI.

In operation 815, the base station allocates a UE SRS BW via a UE-specific SRS configuration.

In operation 820, the base station determines whether the UE SRS BW is smaller (or narrower) than the UE BW. When the UE SRS BW is smaller than the UE BW, the base station performs operation 825; otherwise, the base station performs operation 830.

In operation 825, the base station receives an SRS while performing frequency hopping in the UE BW. In operation 830, the base station receives a wideband SRS in the UE BW.

Referring to FIG. 9, in operation 905, the UE receives an SRS BW from the base station through an SIB.

In operation 910, the UE receives a UE BW corresponding to a bandwidth part that the UE can actually support through at least one of RRC, MAC CE, DCI, and a data channel. The UE may report information on the BW that the UE can support to the base station, and the base station may set the UE BW on the basis of the information received from the UE.

In operation 915, the UE may be allocated a UE SRS BW from the base station through a UE-specific SRS configuration.

In operation 920, the UE may determine whether the UE SRS BW is smaller than the UE BW. When the UE SRS BW is smaller than the UE BW, the UE performs operation 925; otherwise, the UE performs operation 930.

In operation 925, the UE transmits an SRS while performing frequency hopping in the UE BW. In operation 930, the UE transmits a wideband SRS in the UE BW.

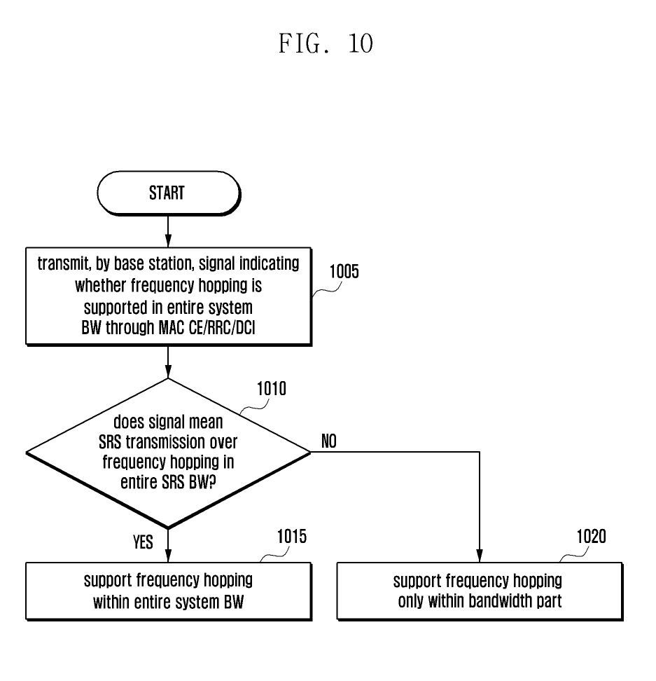

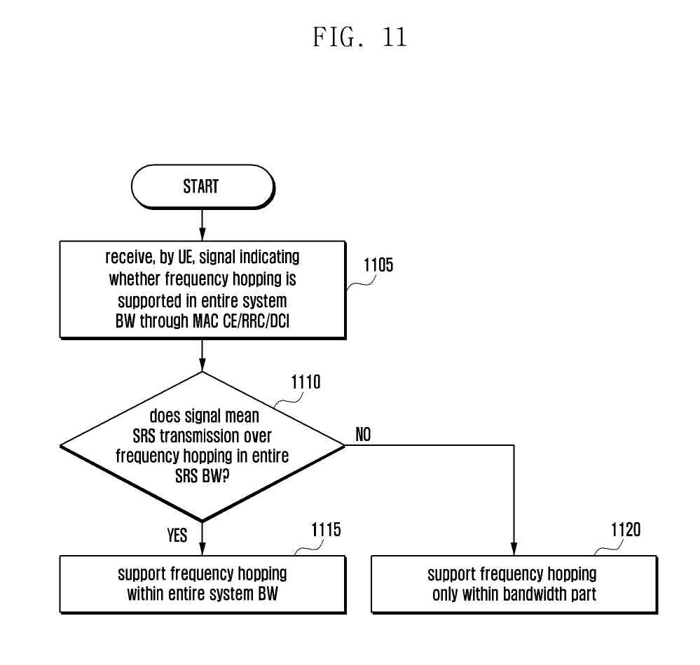

In addition, signaling to enable frequency hopping in the entire system BW may be considered. That is, as illustrated in FIGS. 10 and 11, a base station and a UE may exchange a signal indicating whether frequency hopping is supported in the entire system bandwidth through MAC CE, DCI, or RRC. When the signal is 0, frequency hopping is not supported over the entire system bandwidth. When the signal is 1, transmission may be performed by frequency hopping over the entire system bandwidth. The signal values may be applied in the reverse manner. FIG. 10 illustrates a signaling example for a base station to support frequency hopping within a bandwidth part and a system bandwidth.

Referring to FIG. 10, in operation 1005, the base station may transmit, to a UE, a signal indicating whether frequency hopping is supported in the entire system bandwidth through MAC CE, RRC, or DCI.

In operation 1010, the base station may determine whether the signal indicating whether frequency hopping is supported means support of SRS transmission by frequency hopping over the entire SRS bandwidth. When such SRS transmission is supported, the base station performs operation 1015; otherwise, the base station performs operation 1020.

In operation 1015, the base station determines that frequency hopping is supported over the entire system bandwidth and may receive an SRS while performing frequency hopping over the entire system bandwidth. In operation 1020, the base station determines that frequency hopping is supported only within a bandwidth part allocated to the UE and may receive an SRS while performing frequency hopping only within the bandwidth part.

FIG. 11 illustrates a signaling example for a UE to support frequency hopping within a bandwidth part and a system bandwidth.

Referring to FIG. 11, in operation 1105, the UE may receive, from a base station, a signal indicating whether frequency hopping is supported over the entire system bandwidth through MAC CE, RRC, or DCI.

In operation 1110, the UE may determine whether the signal indicating whether frequency hopping is supported means support of SRS transmission by frequency hopping over the entire SRS bandwidth. When such SRS transmission is supported, the UE performs operation 1115; otherwise, the UE performs operation 1120.

In operation 1115, the UE determines that frequency hopping is supported over the entire system bandwidth and may transmit an SRS while performing frequency hopping over the entire system bandwidth. In operation 1120, the UE determines that frequency hopping is supported only within an allocated bandwidth part and may transmit an SRS while performing frequency hopping only within the bandwidth part.

Unlike frequency switching, frequency hopping over the entire system bandwidth is a method that supports frequency hopping while changing a bandwidth part in order to sound the entire system bandwidth.

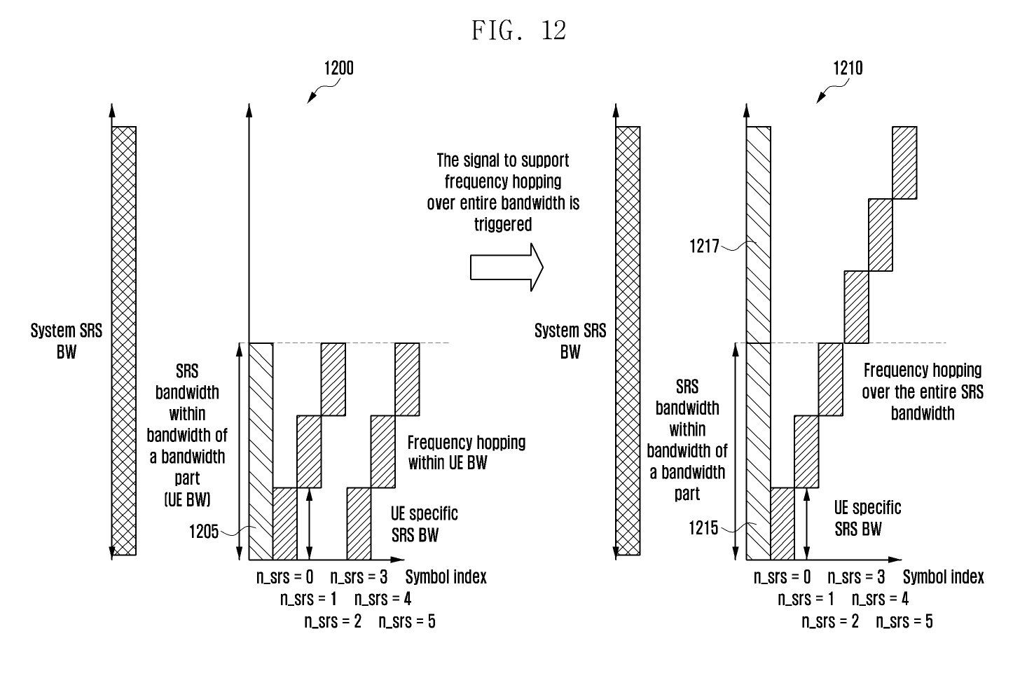

FIG. 12 illustrates transmission of an SRS through signaling support of frequency hopping between bandwidth parts in a system bandwidth.

Referring to FIG. 12, 1200 shows that hopping is performed through frequency switching in a UE bandwidth part 1205. 1210 shows that there are two UE bandwidth parts 1215 and 1217 and that frequency hopping is performed while changing a bandwidth part.

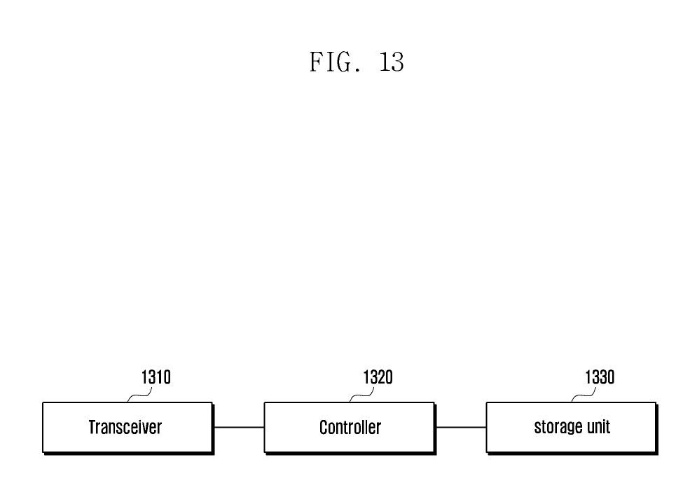

FIG. 13 illustrates the structure of a UE according to an embodiment of the disclosure.

Referring to FIG. 13, the UE may include a transceiver 1310, a controller 1320, and a storage unit 1330. In the disclosure, the controller may be defined as a circuit, an application-specific integrated circuit, or at least one processor.

The transceiver 1310 may transmit or receive a signal to or from another network entity. For example, the transceiver 1310 may receive system information from a base station and may receive a synchronization signal or a reference signal.

The controller 1320 may control the overall operations of the UE according to embodiments of the disclosure. For example, the controller 1320 may control signal flow between blocks to perform the operations illustrated above in the flowcharts of FIGS. 7, 9, and 11.

The storage unit 1330 may store at least one of information transmitted or received through the transceiver 1310 and information generated through the controller 1320.

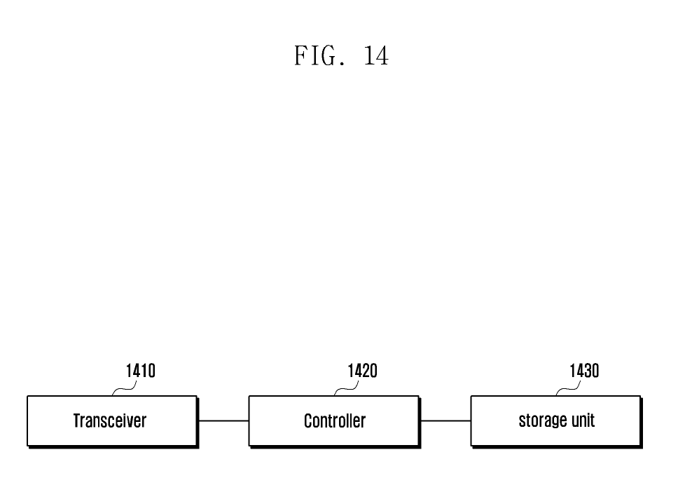

FIG. 14 illustrates the structure of a base station according to an embodiment of the disclosure.

Referring to FIG. 14, the base station may include a transceiver 1410, a controller 1420, and a storage unit 1430. In the disclosure, the controller may be defined as a circuit, an application-specific integrated circuit, or at least one processor.

The transceiver 1410 may transmit or receive a signal to or from another network entity. For example, the transceiver 1410 may transmit system information from a UE and may transmit a synchronization signal or a reference signal.

The controller 1420 may control the overall operations of the base station according to embodiments of the disclosure. For example, the controller 1420 may control signal flow between blocks to perform the operations illustrated above in the flowcharts of FIGS. 6, 8, and 10.

The storage unit 1430 may store at least one of information transmitted or received through the transceiver 1410 and information generated through the controller 1420.

What is claimed is:

1. A method by a terminal, the method comprising:
receiving, from a base station, first sounding reference signal (SRS) configuration information including first SRS resource and a usage of the first SRS resource;
receiving, from the base station, second SRS configuration information including second SRS resource and a usage of the second SRS resource; and
transmitting, to the base station, first SRS based on the first SRS configuration information and a second SRS based on the second SRS configuration information.

2. The method of claim 1,
wherein each of the usage of the first SRS resource and the usage of the second SRS resource indicates one of a beam management or a CSI acquisition.

3. The method of claim 1,
wherein if the first SRS resource corresponds to a beam management and the second SRS resource corresponds to a CSI acquisition, the first SRS resource is different from the second SRS resource.

4. The method of claim 1, further comprising:
receiving a dedicated radio resource control (RRC) message including entire bandwidth information for a SRS transmission.

5. The method of claim 1,
wherein the entire bandwidth information is configured based on a bandwidth part supported by the terminal.

6. A terminal comprising:
a transceiver configured to transmit and receive a signal; and
a controller configured to:
receive, from a base station, first sounding reference signal (SRS) configuration information including first SRS resource and a usage of the first SRS resource;
receive, from the base station, second SRS configuration information including second SRS resource and a usage of the second SRS resource; and
transmit, to the base station, first SRS based on the first SRS configuration information and a second SRS based on the second SRS configuration information.

7. The terminal of claim 6,
wherein each of the usage of the first SRS resource and the usage of the second SRS resource indicates one of a beam management or a CSI acquisition.

8. The terminal of claim 6,
wherein if the first SRS resource corresponds to a beam management and the second SRS resource corresponds to a CSI acquisition, the first SRS resource is different from the second SRS resource.

9. The terminal of claim 6, wherein the controller is further configured to receive a dedicated radio resource control (RRC) message including entire bandwidth information for a SRS transmission.

10. The terminal of claim 6,
wherein the entire bandwidth information is configured based on a bandwidth part supported by the terminal.

11. A method by a base station, the method comprising:
transmitting, to a terminal, first sounding reference signal (SRS) configuration information including first SRS resource and a usage of the first SRS resource;
Transmitting, to the terminal, second SRS configuration information including second SRS resource and a usage of the second SRS resource; and
receiving, from the terminal, first SRS based on the first SRS configuration information and a second SRS based on the second SRS configuration information.

12. The method of claim 11,
wherein each of the usage of the first SRS resource and the usage of the second SRS resource indicates one of a beam management or a CSI acquisition.

13. The method of claim 11,
wherein if the first SRS resource corresponds to a beam management and the second SRS resource corresponds to a CSI acquisition, the first SRS resource is different from the second SRS resource.

14. The method of claim 11, further comprising:
transmitting a dedicated radio resource control (RRC) message including entire bandwidth information for a SRS transmission.

15. The method of claim 11,
wherein the entire bandwidth information is configured based on a bandwidth part supported by the terminal.

16. A base station comprising:
a transceiver configured to transmit and receive a signal; and
a controller configured to:
transmit, to a terminal, first sounding reference signal (SRS) configuration information including first SRS resource and a usage of the first SRS resource;
transmit, to the terminal, second SRS configuration information including second SRS resource and a usage of the second SRS resource; and
receive, from the terminal, first SRS based on the first SRS configuration information and a second SRS based on the second SRS configuration information.

17. The base station of claim 16,
wherein each of the usage of the first SRS resource and the usage of the second SRS resource indicates one of a beam management or a CSI acquisition.

18. The base station of claim 16,
wherein if the first SRS resource corresponds to a beam management and the second SRS resource corresponds to a CSI acquisition, the first SRS resource is different from the second SRS resource.

19. The base station of claim 16, wherein the controller is further configured to transmit a dedicated radio resource control (RRC) message including entire bandwidth information for a SRS transmission.

20. The base station of claim 16,
wherein the entire bandwidth information is configured based on a bandwidth part supported by the terminal.
